(19) United States
(12) Patent Application Publication
(10) Pub. No.: US 2025/0296059 A1
(43) Pub. Date: Sep. 25, 2025

(54) CONCRETE SPLASH SHIELD ARRANGEMENT

(71) Applicant: Oscar Gonzalez, Brighton, CO (US)

(72) Inventor: Oscar Gonzalez, Brighton, CO (US)

(21) Appl. No.: 19/229,204

(22) Filed: Jun. 5, 2025

Related U.S. Application Data
(63) Continuation-in-part of application No. 18/206,314, filed on Jun. 6, 2023.

(51) Int. Cl. B01F 35/00; B01F 101/28; E04G 21/08

(52) U.S. Cl. CPC B01F 35/186; E04G 21/08; B01F 2101/28

(57) ABSTRACT

A splash shield configured for use with a concrete needle vibrator is disclosed. The splash shield protects concrete workers by enclosing the vibrating needle head and containing splashing concrete within its housing, thereby preventing direct exposure to wet concrete during operation. The splash shield comprises a housing having a top end and a bottom end, wherein the bottom end is configured to rest on uncured concrete. A head receiving port at the top end is adapted to receive a vibrating needle head. A plurality of slits extend along the housing from the head receiving port, defining a flexible region that expands and contracts around the needle head. A strap arrangement is coupled to the housing and configured to tighten the flexible region for a secure fit. The bottom end of the housing includes a flange that distributes the weight of the shield over the uncured concrete. An aperture within the inner boundary of the flange allows concrete splash to enter the interior of the housing and contact its interior surface.

### CROSS-REFERENCE TO RELATED APPLICATIONS

This application is a continuation-in-part patent application claiming priority to and the benefit of patent application Ser. No. 18/206,314, entitled Concrete V-Shield, filed Jun. 6, 2023, the entire disclosure of which is hereby incorporated by reference.

### FIELD OF THE INVENTION

The present embodiments are generally directed to a concrete splash guard used with a concrete needle probe vibrator.

### DESCRIPTION OF RELATED ART

Freshly poured concrete often clumps together thereby failing to fully settle into all corners of the formwork or around embedded reinforcement. Moreover, entrapped air in the concrete can lead to compromised structural integrity. Without proper consolidation, the concrete may not achieve its designed strength or durability, increasing the risk of premature failure or surface defects.

To address these issues, concrete needle vibrators, also known as an immersion or poker vibrators, are typically used to mechanically agitate or otherwise vibrate the concrete after it is poured. FIG. 1 is an example of a concrete needle vibrator 100 that generally comprises a long, flexible shaft 102 connected to a vibrating metal head 104 via a coupling 114 at the distal end of the flexible shaft 102. During operation, at least to a distal portion 112 of the vibrating metal head 104 is inserted directly into the uncured and unsettled freshly poured concrete 106. When activated via a vibrator motor 105, the metal head 104 rapidly vibrates (depicted by the waves 108 in the concrete 106), disrupting the internal friction in the concrete 106, allowing air bubbles to escape, and causing the concrete 106 to settle into a dense, uniform slurry. This process ensures that the concrete 106 fully encapsulates reinforcement, fills voids, and achieves maximum compaction for improved performance and longevity.

While a concrete needle vibrator 100 provides essential benefits to concrete compaction and distribution, it can also cause splashing 110 during operation. Splashing concrete 110 presents a safety hazard in that fresh/wet concrete contains alkaline compounds and other chemicals that can irritate or damage skin and eyes upon contact. To mitigate these risks, workers need to wear appropriate protective equipment, including face shields, gloves, and chemical-resistant clothing, to safeguard against chemical exposure and maintain a safe working environment. However, safety protocols are not always followed, placing concrete workers at risk of chemical exposure and injury. It is to improvements to protecting against splashing concrete when using a concrete needle probe vibrator that the claimed invention is generally directed.

### SUMMARY OF THE INVENTION

The present embodiments are generally directed to a concrete splash guard used with a concrete needle probe vibrator.

Accordingly, certain embodiments contemplate a splash shield that is configured for use with a concrete needle vibrator. The splash shield generally comprising a housing, a strap arrangement for clamping a head receiving port around a vibrating needle that extends through an aperture in the bottom of the splash shield. More specifically, the housing has a top end and a bottom end, wherein the bottom end is configured to rest on uncured concrete. The head receiving port is located at the top end and configured to receive a vibrating needle head. A plurality of slits extend from the head receiving port along the housing, which define a flexible region configured to expand and contract around the needle head. The strap arrangement is coupled to the housing and configured to tighten the flexible region around the needle head. The flange extends outwardly from the bottom end and is configured to distribute the weight of the housing over the uncured concrete. The aperture is defined within an inner boundary of the flange and is configured to permit concrete splash to enter an interior of the housing and contact an interior surface.

Another embodiment of the present invention contemplates a splash shield arrangement that has a housing having a top end and a bottom end, wherein the bottom end is configured to rest on uncured concrete. The splash shield arrangement further has a size adjustable head receiving port at the top end that is configured to receive a vibrating needle head of a concrete needle vibrator. A strap arrangement is coupled to the housing and is configured to tighten the size adjustable head receiving port around the needle head or a flexible cable connected to the needle head. The splash shield arrangement also comprises a flange having a bottom surface that extends in a plane outwardly from the bottom end, wherein the flange is configured to distribute the weight of the housing over the uncured concrete. An aperture is defined within an inner boundary of the flange and is configured to permit concrete splash to enter an interior of the housing.

Still another embodiment of the present invention contemplates a needle vibrator splash shield that comprises a housing, a plurality of slits, a strap arrangement and an aperture. The housing extends between a head receiving port and a flange, wherein the flange is configured to rest on uncured concrete. The plurality of slits extend from the head receiving port along the housing, wherein the slits define a flexible region that is configured to expand and contract around either the needle head or a flexible cable connected to the needle head. The strap arrangement is coupled to the housing and is configured to contract the flexible region. The aperture is defined within an inner boundary of the flange and is configured to permit concrete splash to enter an interior of the housing. The flange extends in a plane radially outwardly from a bottom end of the housing.

### BRIEF DESCRIPTION OF THE DRAWINGS

FIG. 1 is a prior art example of a concrete needle vibrator;

FIGS. 2A and 2B are line drawings that illustratively depict a splash shield embodiment consistent with embodiments of the present invention;

FIGS. 2C and 2D and are line drawings that illustratively depict the splash shield embodiment viewed from the bottom up and from the top down, respectively, consistent with embodiments of the present invention;

FIG. 3 is a line drawing illustratively depicting a needle head engaged with the splash shield embodiment, consistent with embodiments of the present invention;

FIG. 4 is a line drawing that illustratively depicts the use of a flexible cable retaining ring to retain the splash shield embodiment over the needle head, consistent with embodiments of the present invention; and

FIG. 5 is a line drawing that illustratively depicts a handle extending from the splash shield embodiment, consistent with embodiments of the present invention.

### DETAILED DESCRIPTION

Initially, this disclosure is by way of example only, not by limitation. Thus, although the instrumentalities described herein are for the convenience of explanation, shown and described with respect to exemplary embodiments, it will be appreciated that the principles herein may be applied equally in other similar configurations involving the subject matter directed to the field of the invention. The phrases “in one embodiment”, “according to one embodiment”, and the like, generally mean the particular feature, structure, or characteristic following the phrase, is included in at least one embodiment of the present invention and may be included in more than one embodiment of the present invention. Importantly, such phrases do not necessarily refer to the same embodiment. If the specification states a component or feature “may”, “can”, “could”, or “might” be included or have a characteristic, that particular component or feature is not required to be included or have the characteristic. As used herein, the terms “having”, “have”, “including” and “include” are considered open language and are synonymous with the term “comprising”. Furthermore, as used herein, the term “essentially” is meant to stress that a characteristic of something is to be interpreted within acceptable tolerance margins known to those skilled in the art in keeping with typical normal world tolerance, which is analogous with “more or less.” For example, essentially flat, essentially straight, essentially on time, etc. all indicate that these characteristics are not capable of being perfect within the sense of their limits. Accordingly, if there is no specific +/− value assigned to “essentially”, then assume essentially means to be within +/−2.5% of exact. The term “connected to” as used herein is to be interpreted as a first element physically linked or attached to a second element and not as a “means for attaching” as in a “means plus function”. In fact, unless a term expressly uses “means for” followed by the gerund form of a verb, that term shall not be interpreted under 35 U.S.C. § 112 (f). In what follows, similar or identical structures may be identified using identical callouts. Further, the term “one” is synonymous with “a”, which may be a first of a plurality.

With respect to the drawings, it is noted that the figures are not necessarily drawn to scale and are diagrammatic in nature to illustrate features of interest. Descriptive terminology such as, for example, upper/lower, top/bottom, horizontal/vertical, left/right and the like, may be adopted with respect to the various views or conventions provided in the figures as generally understood by an onlooker for purposes of enhancing the reader's understanding and is in no way intended to be limiting. All embodiments described herein are submitted to be operational irrespective of any overall physical orientation unless specifically described otherwise, such as elements that rely on gravity to operate, for example.

In general, the embodiments below are directed to inventive aspects of a splash shield configured for use with a concrete needle vibrator 100. The exemplified splash shield embodiments protect concrete workers by enclosing the vibrating needle head and containing splashing concrete within its housing, thereby preventing direct exposure to wet concrete during operation. In one embodiment, the splash shield comprises a housing having a top end and a bottom end, wherein the bottom end is configured to rest on uncured concrete. A head receiving port at the top end is adapted to receive a vibrating needle head. A plurality of slits extend along the housing from the head receiving port, defining a flexible region that expands and contracts around the needle head. A strap arrangement is coupled to the housing and configured to tighten the flexible region for a secure fit. The bottom end of the housing includes a flange that distributes the weight of the shield over the uncured concrete. An aperture within the inner boundary of the flange allows concrete splash to enter the interior of the housing and contact its interior surface.

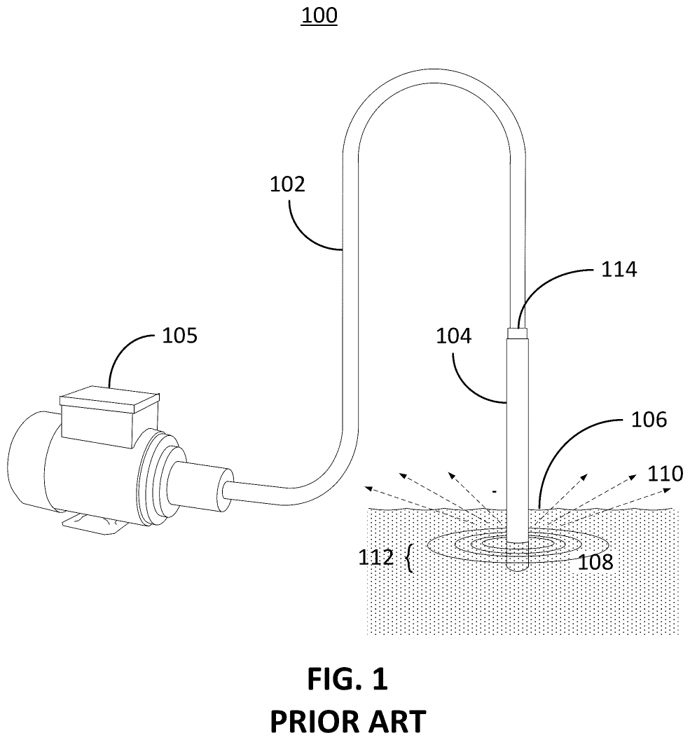

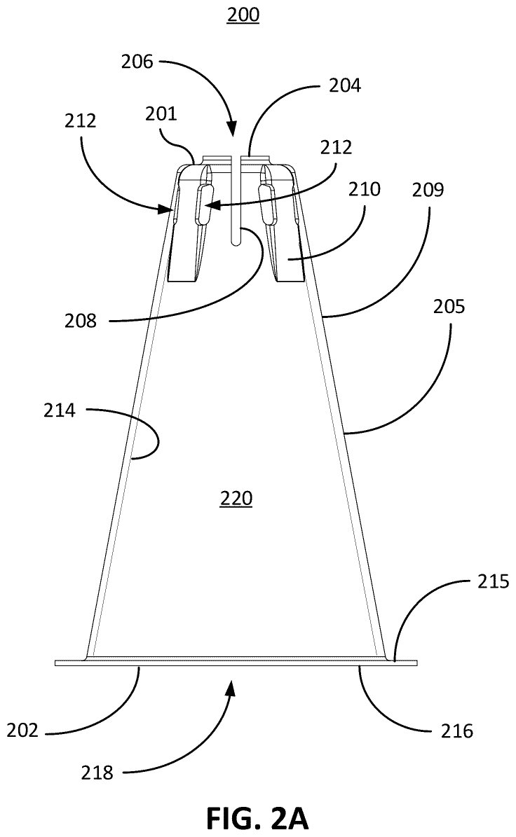

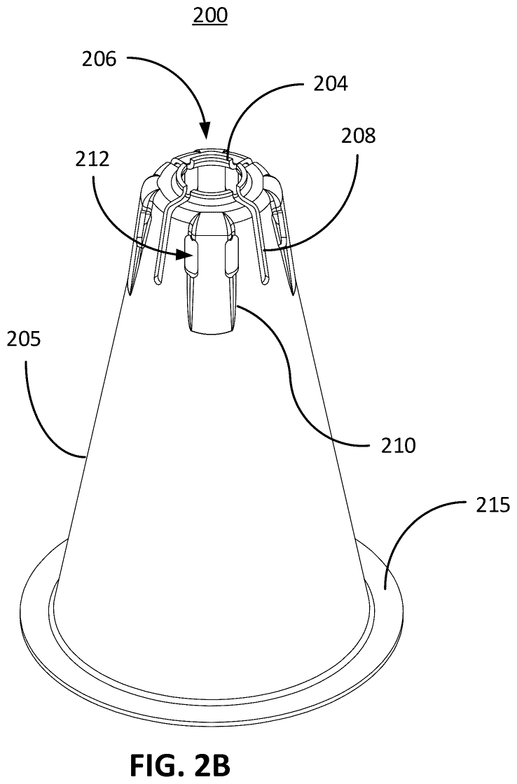

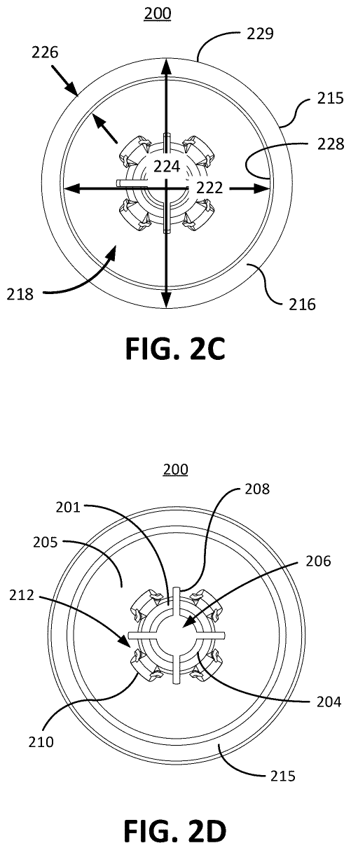

As discussed above, one problem when using a needle vibrator 100 is the risk of splashing concrete on the operator or those nearby. FIGS. 2A and 2B are line drawings that illustratively depict a splash shield embodiment 200 consistent with embodiments of the present invention. FIG. 2A depicts a side view of the splash shield embodiment 200, which is described in view of the isometric line drawing of FIG. 2B. As shown, the splash shield 200 comprises a cone shaped housing 205 (or simply “housing”) that extends between a pressure distribution flange 215 at the housing bottom end 202 and a receiving sleeve 204 at the housing top end 201. Certain embodiments contemplate the distance between the housing bottom end 202 and the housing top end 201 being between 12-36 inches, while other embodiments contemplate larger or smaller housings. The interior space 220 of the splash shield 200 is configured to entrap concrete splash 110 from a vibrating needle head 104 when connected to the splash shield 200. The receiving sleeve 204 is configured and arranged to receive a needle head 104 depicted in FIG. 1. Certain embodiments contemplate the receiving sleeve 204 being funnel shaped with the wider side of the funnel defining the upper surface of the head receiving port 206 to more easily receive a needle vibrator 100 when inserted into the splash shield 200. The housing 205 may be transparent or opaque and can be fabricated from any suitable material, such as PVC, another polymer, or metal, for example. A lightweight polymer housing 205 is preferred because the splash shield 200 is configured and arranged to rest atop fresh/uncured concrete 106 and needs to be easily maneuverable by a concrete operator.

With respect to the bottom end 202, the splash shield 200 is arranged and configured to rest atop uncured concrete, with a splash region of the concrete 106 exposed to the interior surface 214 of the housing via a base aperture 218. The base aperture 218 is defined as the area within the interior flange diameter 222 of the pressure distribution flange 215, as shown in the bottom view of the splash shield 200 in FIG. 2C. The interior flange diameter 222 is sized to encircle or otherwise cover the splash region, defined as the area of uncured concrete that may splash due to the vibration of the activated needle head 104. In certain embodiments, the interior flange diameter 222 ranges between 8 and 24 inches; however, other dimensions are contemplated within the scope and spirit of the invention. The pressure distribution flange 215 comprises an annular ring with a flat concrete-interfacing surface 216 that is essentially planar (i.e., the flange's flat concrete-interfacing surface 216 lies along or is otherwise entirely contained in a plane) that extends horizontally from the housing bottom end 202. The pressure distribution flange 215 is configured to distribute the weight of the splash shield 200, along with the weight contributed by the connected needle head 104 and flexible shaft 102. Since pressure is defined as force over area, a larger concrete-interfacing surface 216 results in lower pressure, making the splash shield 200 less disruptive to the concrete surface 106 and easier to move on and off the concrete. In some embodiments, the flange width 226 (defined between the outer flange boundary/rim 229 and inner flange boundary 228) may range between 0.25 and 1.5 inches, although other widths are also envisioned. Additionally, certain embodiments contemplate a concrete-phobic coating on the concrete-interfacing surface 216 to reduce the likelihood of adhesion to the concrete 106.

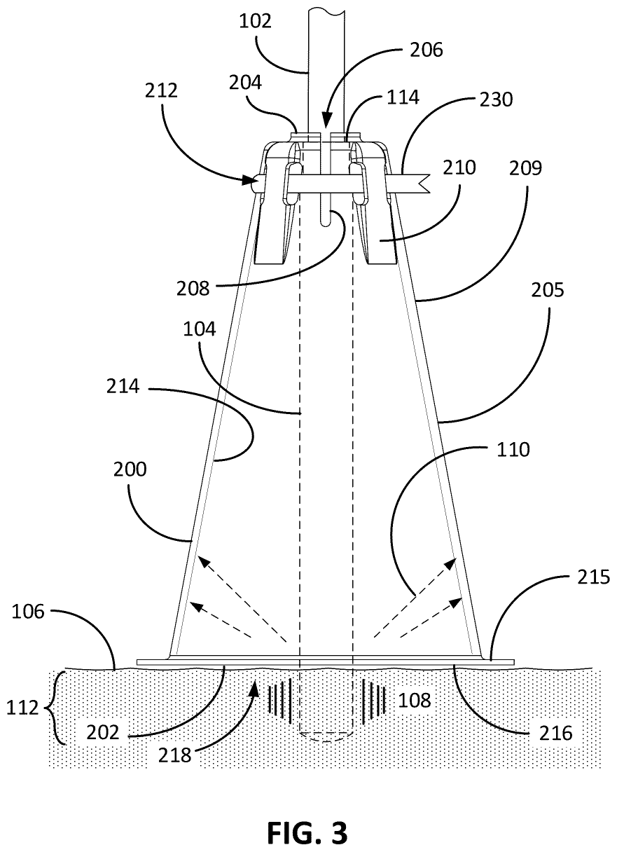

With respect to the housing top end 201 of the splash shield 200, as shown, the top end 201 features a centrally positioned head receiving port 206, defined by a surrounding receiving sleeve 204. The head receiving port 206 is configured and arranged to accommodate and connect with a needle head 104 and/or the flexible shaft 102. The head receiving port 206 is configured to or otherwise capable of opening and closing around the needle head 104 through a plurality of flex slit 208, which extend from the head receiving port 206 to a depth between one-tenth and one-sixth of the distance from the top end 201 to the bottom end 202. In the present embodiment, four flex slit 208 are shown; however, more or fewer may be used without departing from the scope and spirit of the invention. Additionally, the flex slits 208 need not be linear or follow a direct path from the head receiving port 206 to the bottom end 202, but may assume various shapes and sizes, provided they enable the head receiving port 206 to expand and contract. Interposed between each of the flex slits 208 is a strap casing 210 with a through-slot 212 resembling a belt loop. Each strap casing 210 is mounted upright on the housing 205 (i.e., the strap casings 210 extend outward) and defines a clear passage through the through-slot 212, allowing a strap 230, as shown in FIG. 3, to cinch the flex slits 208 tightly and secure the needle head 104 in place. The through-slots 212 are essentially at the level of the housing outer surface 209 so that the strap 230 is in near optimal contact with the housing outer surface 209. In the present embodiment, the strap casing 210 (as well as all of the other components) are molded (or printed) as a unitary piece of material, while other embodiments envision these components affixed, glued or otherwise attached to the housing 205.

FIG. 2D is a top view line drawing of the top end 201 of the splash shield 200 (looking down on the splash shield 200), illustrating the head receiving port 206 and four flex slits 208 that together form a contiguous opening. This opening is in fluid communication with the base aperture 218 when the pressure distribution flange 215 is not resting atop the concrete 106. Fluid communication is defined as facilitating fluid to pass into the base aperture 218 and out through the head receiving port 206 and four flex slits 208 without obstruction. Also shown are the four strap casings 210, each with a through-slot 212, evenly distributed around the circumference of the cone-shaped housing 205.

FIG. 3 is a line drawing illustratively depicting a needle head 104 engaged with the splash shield embodiment 200, consistent with embodiments of the present invention. As shown, the splash shield 200 is connected to a concrete needle vibrator 100 and is resting atop fresh or uncured concrete 106. More specifically, the flat concrete-interfacing surface 216 of the pressure distribution flange 215 supports the splash shield 200 along with the weight of the vibrating needle head 104 and flexible shaft 102. As previously discussed, the width of the flange 226 determines the amount of pressure imparted on the surface of the fresh concrete 106.

The head receiving port 206 is secured around the needle head 104 by a cinching strap 230, which is threaded through the through-slots 212 in the strap casings 210 and tightened to close the gaps defined by the flex slits 208. In this embodiment, the coupling 114 at the top of the needle head 104 includes a lip that can engage with a corresponding lip on the receiving sleeve 204 to help set, catch, or otherwise lock the needle head 104 in place. The cinching strap 230 may take various forms, such as a belt with a locking buckle, a disposable zip-tie, a ratchet strap, or similar mechanisms.

FIG. 3 further depicts a distal portion 112 of the vibrating needle head 104 partially submerged in the fresh concrete 106. Vibrations 108 cause concrete to splash 110 into the interior 220 of the splash shield 200 through the base aperture 218, where it contacts the housing interior surface 214. As a result, the splash shield 200 captures the splashing concrete 110, helping to protect nearby concrete workers.

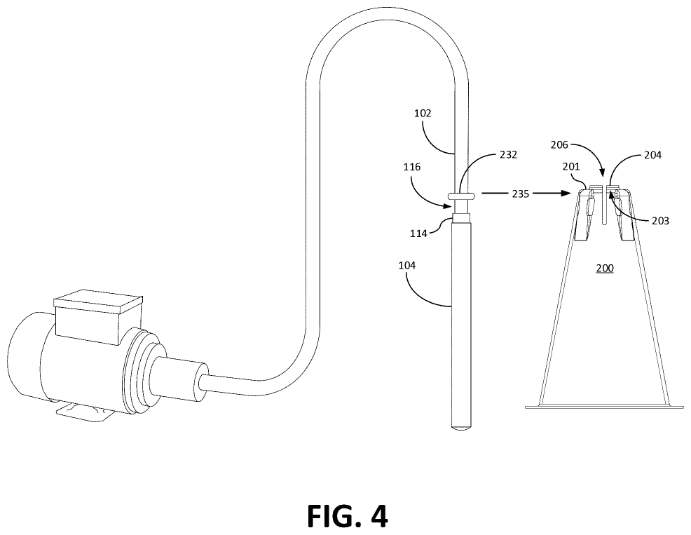

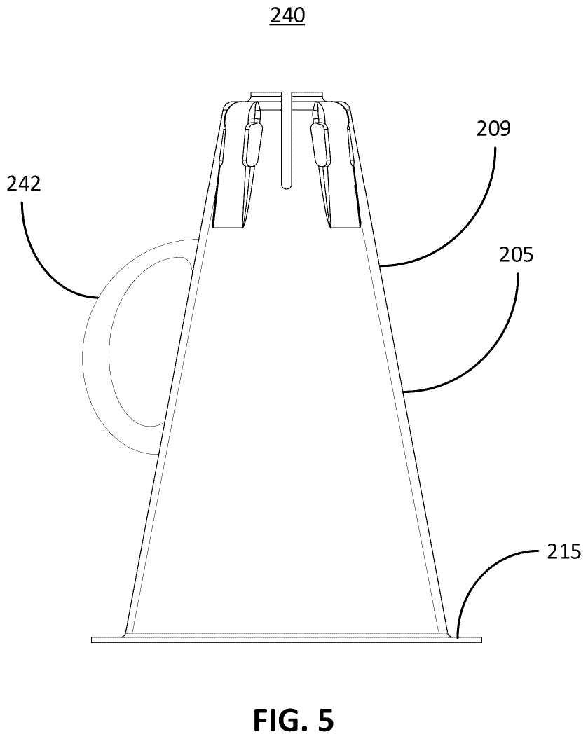

FIG. 4 is a line drawing that illustratively depicts the use of a flexible cable retaining ring 232 to retain the splash shield embodiment 200 over the needle head 104, consistent with embodiments of the present invention. As shown, the retaining ring 232 is fixed to the flexible cable 102 above the needle head 104, leaving a distal portion 116 of the flexible cable 102 exposed between the retaining ring 232 and the needle head 104. In some embodiments, the retaining ring 232 may be positioned in contact with the needle head 104 or the needle head coupling 114. As shown by the horizontal arrow 235, the receiving sleeve shoulder 203 of the receiving sleeve 204 engages the retaining ring 232. When the head receiving port 206 is cinched closed, the splash shield 200 hangs from the flexible cable 102, thereby remaining retained over at least a portion of the needle head 104.

FIG. 5 is a line drawing that illustratively depicts a handle extending from the splash shield embodiment 240, consistent with embodiments of the present invention. In this embodiment, a handle 242 extends outwardly from the outer surface 209 of the housing 205. The handle 242 is configured to facilitate holding, carrying, and maneuvering the splash shield 240. The handle may be a separately fixed component or, optionally, integrally molded or printed with the housing as a single unified element.

With the present description in mind, below are some examples of certain embodiments illustratively complementing some of the methods and apparatus embodiments discussed above and presented in the figures to aid the reader. Accordingly, the elements called out below are provided by example to aid in the understanding of the present invention and should not be considered limiting. The reader will appreciate that the below elements and configurations can be interchangeable within the scope and spirit of the present invention. The illustrative embodiments can include elements from the figures.

In that light, Accordingly, certain embodiments contemplate a splash shield 200 (as shown in FIGS. 2A and 2B) that is configured for use with a concrete needle vibrator 100 (See FIG. 1). The splash shield 200 generally comprises a housing 205, a strap arrangement 210/212 for clamping a head receiving port 206 around a vibrating needle 104 that extends through an aperture in the bottom of the splash shield 200. More specifically, the housing 205 has a top end 201 and a bottom end 202, wherein the bottom end 202 is configured to rest on uncured concrete 106. The head receiving port 206 is located at the top end 201 and configured to receive a vibrating needle head 104. A plurality of slits 208 extend from the head receiving port 206 along the housing 205, which define a flexible region configured to expand and contract around the needle head 104. The strap arrangement 210/212 is coupled to the housing 205 and configured to tighten the flexible region around the needle head 104. The flange 215 extends outwardly from the bottom end 202 and is configured to distribute the weight of the housing 205 over the uncured concrete 106. The aperture 218 is defined within an inner boundary 228 of the flange 215 and is configured to permit concrete splash 110 to enter an interior 220 of the housing 205 and contact an interior surface 214.

The splash shield 200 further envisioning the strap arrangement 210/212 comprising a strap threaded through one or more strap casings 210 that extend from the housing 205.

The splash shield 200 further imagines the strap arrangement 210/212 comprising a locking buckle, ratchet, or cinching strap 230.

The splash shield 200 further contemplates the flange 215 being an annular structure that extends radially outward from the housing 205.

The splash shield 200 further ponders the slits 208 defining four discrete segments that are arranged symmetrically around the head receiving port 206.

The splash shield 200 further envisions the housing 205 being a transparent polymer.

The splash shield 200 further imagines the housing 205 being generally conical in shape.

The splash shield 200 further contemplates the head receiving port 206 including a receiving sleeve 204 that is configured to engage a lip or flange of the needle head 104.

The splash shield 200 further envisions the flange 215 being integrally formed with the housing 205.

The splash shield 200 further imagines the interior surface 214 of the housing 205 being coated or treated to resist adhesion of concrete splatter 110, such as oil, Teflon, wax, or some other coating known to those in the chemical arts.

Another embodiment of the present invention contemplates a splash shield arrangement 200 that has a housing 205 having a top end 201 and a bottom end 202, wherein the bottom end 202 is configured to rest on uncured concrete 106. The splash shield arrangement 200 further has a size adjustable head receiving port 206 at the top end 201 that is configured to receive a vibrating needle head 104 of a concrete needle vibrator 100. A strap arrangement 210/212 is coupled to the housing 205 and is configured to tighten the size adjustable head receiving port 206 around the needle head 104 or a flexible cable 102 connected to the needle head 104. The splash shield arrangement 200 also comprises a flange 215 having a bottom surface 216 that extends in a plane outwardly from the bottom end 202, wherein the flange 215 is configured to distribute the weight of the housing 205 over the uncured concrete 106. An aperture 218 is defined within an inner boundary 228 of the flange 215 and is configured to permit concrete splash 110 to enter an interior 220 of the housing 205.

The splash shield arrangement 200 can further comprise a plurality of slits 208 that extend from the head receiving port 206 along the housing 205, wherein the slits 208 define a flexible region in the housing 205 that is configured to expand and contract around either the needle head 104 or a flexible shaft 102 that is connected to the needle head 104.

The splash shield arrangement 200 can further comprise a receiving sleeve 204 at the size adjustable head receiving port 206, wherein the receiving sleeve 204 is funnel shaped.

The splash shield arrangement 200 further imagines the size adjustable head receiving port 206 being configured to cinch the flexible shaft 102 above a cable ring 232 that fixed to the flexible cable 102, wherein the cable ring 232 is configured to retain the splash shield arrangement 200 to cover a majority of the needle head 104.

The splash shield arrangement 200 further envisions when the vibrating needle head 104 is connected to the splash shield arrangement 200, a distal portion 112 of the vibrating needle head 104 extends through the aperture 218.

Still another embodiment of the present invention contemplates a needle vibrator splash shield 200 that comprises a housing 205, a plurality of slits 208, a strap arrangement 210/212 and an aperture 218. The housing 205 extends between a head receiving port 206 and a flange 215, wherein the flange 215 is configured to rest on uncured concrete 106. The plurality of slits 208 extend from the head receiving port 206 along the housing 205, wherein the slits 208 define a flexible region that is configured to expand and contract around either the needle head 104 or a flexible cable 102 connected to the needle head 104. The strap arrangement 210/212 is coupled to the housing 205 and is configured to contract the flexible region. The aperture 218 is defined within an inner boundary 228 of the flange 215 and is configured to permit concrete splash 110 to enter an interior 220 of the housing 205. The flange extends in a plane radially outwardly from a bottom end 202 of the housing 205.

The needle vibrator splash shield 200 is further envisioned to have the strap arrangement 210/212 comprise a strap 230 that is threaded through one or more strap casings 210 extending from the housing 205.

The needle vibrator splash shield 200 further imagines the slits 208 defining four discrete segments that are arranged symmetrically around the head receiving port 206.

The needle vibrator splash shield 200 further contemplates the housing 205 being a transparent polymer.

The needle vibrator splash shield 200 further envisions the housing 205 being generally conical in shape or box shaped or some other shape that suits the functionality of a shield surrounding a needle head 104.

The above sample embodiments should not be considered limiting to the scope of the invention whatsoever because many more embodiments and variations of embodiments are easily conceived within the teachings, scope and spirit of the instant specification.

It is to be understood that even though numerous characteristics and advantages of various embodiments of the present invention have been set forth in the foregoing description, together with the details of the structure and function of various embodiments of the invention, this disclosure is illustrative only, and changes may be made in detail, especially in matters of structure and arrangement of parts within the principles of the present invention to the full extent indicated by the broad general meaning of the terms in which the appended claims are expressed. For example, although the above description discusses embodiments of the strap arrangement 210/212 being coupled to the housing 205 and configured to tighten the flexible region to retain the splash shield embodiment 200 over the needle head 104, it is not necessary for the head receiving port 206 to clamp directly onto the needle head 104, the coupling 114, or the flexible shaft 102. Instead, the head receiving port 206 may simply be sized smaller than the coupling 114 or the cable ring 232 to achieve retention. Also, though the strap 230 is described as potentially being a belt with a buckle, a zip tie or a reversable lock tie, other retaining configurations, such as duct tape, multiple straps, snaps, Velcro, etc., could equally be used while still maintaining substantially the same functionality without departing from the scope and spirit of the present invention. Optionally, instead of a cone shaped housing, other shapes are envisioned without departing from the scope and spirit of the present invention. Another example can include providing various other locking and releasing devices to retain a splash shield over the needle head 104 without departing from the scope and spirit of the present invention. Further, the term “one” is synonymous with “a”, which may be a first of a plurality. In summary, it should be appreciated that elements of various embodiments described herein can be combined in obvious manners by a person skilled in the art that understands the content of the present specification without departing from the scope of the subject matter presented herein.

It will be clear that the present invention is well adapted to attain the ends and advantages mentioned as well as those inherent therein. While presently preferred embodiments have been described for purposes of this disclosure, numerous changes may be made which readily suggest themselves to those skilled in the art and which are encompassed in the appended claims.

What is claimed is:

1. A splash shield configured for use with a concrete needle vibrator, the splash shield comprising:
a housing having a top end and a bottom end, the bottom end configured to rest on uncured concrete;
a head receiving port at the top end configured to receive a vibrating needle head;
a plurality of slits extending from the head receiving port along the housing, the slits defining a flexible region configured to expand and contract around the needle head;
a strap arrangement coupled to the housing and configured to tighten the flexible region around the needle head;
a flange extending outwardly from the bottom end, the flange configured to distribute the weight of the housing over the uncured concrete; and
an aperture defined within an inner boundary of the flange configured to permit concrete splash to enter an interior of the housing and contact an interior surface.

2. The splash shield of claim 1, wherein the strap arrangement comprises a strap threaded through one or more strap casings extending from the housing.

3. The splash shield of claim 1, wherein the strap arrangement comprises a locking buckle, ratchet, or cinching strap.

4. The splash shield of claim 1, wherein the flange is an annular structure extending radially outward from the housing.

5. The splash shield of claim 1, wherein the slits define four discrete segments arranged symmetrically around the head receiving port.

6. The splash shield of claim 1, wherein the housing is a transparent polymer.

7. The splash shield of claim 1, wherein the housing is generally conical in shape.

8. The splash shield of claim 1, wherein the head receiving port includes a receiving sleeve configured to engage a lip or flange of the needle head.

9. The splash shield of claim 1, wherein the flange is integrally formed with the housing.

10. The splash shield of claim 1, wherein the interior surface of the housing is coated or treated to resist adhesion of concrete splatter.

11. A splash shield arrangement comprising:
a housing having a top end and a bottom end, the bottom end configured to rest on uncured concrete;
a size adjustable head receiving port at the top end configured to receive a vibrating needle head of a concrete needle vibrator;
a strap arrangement coupled to the housing and configured to tighten the size adjustable head receiving port around the needle head or a flexible cable connected to the needle head;
a flange having a bottom surface extending in a plane outwardly from the bottom end, the flange configured to distribute the weight of the housing over the uncured concrete; and
an aperture defined within an inner boundary of the flange configured to permit concrete splash to enter an interior of the housing.

12. The splash shield arrangement of claim 11 further comprising a plurality of slits extending from the head receiving port along the housing, the slits defining a flexible region in the housing configured to expand and contract around either the needle head or a flexible shaft connected to the needle head.

13. The splash shield arrangement of claim 11 further comprising a receiving sleeve at the size adjustable head receiving port, wherein the receiving sleeve is funnel shaped.

14. The splash shield arrangement of claim 11, wherein the size adjustable head receiving port is configured to cinch the flexible shaft above a cable ring that fixed to the flexible cable, the cable ring configured to retain the splash shield arrangement to cover a majority of the needle head.

15. The splash shield arrangement of claim 11, wherein when the vibrating needle head is connected to the splash shield arrangement, a distal portion of the vibrating needle head extends through the aperture.

16. A needle vibrator splash shield comprising:
a housing extending between a head receiving port and a flange, wherein the flange is configured to rest on uncured concrete;
a plurality of slits extending from the head receiving port along the housing, the slits defining a flexible region configured to expand and contract around either the needle head or a flexible cable connected to the needle head;
a strap arrangement coupled to the housing and configured to contract the flexible region; and
an aperture defined within an inner boundary of the flange configured to permit concrete splash to enter an interior of the housing, the flange extending in a plane radially outwardly from a bottom end of the housing.

17. The needle vibrator splash shield of claim 16, wherein the strap arrangement comprises a strap threaded through one or more strap casings extending from the housing.

18. The needle vibrator splash shield of claim 16, wherein the slits define four discrete segments arranged symmetrically around the head receiving port.

19. The needle vibrator splash shield of claim 16, wherein the housing is a transparent polymer.

20. The needle vibrator splash shield of claim 16, wherein the housing is generally conical in shape.
